(19) United States
(12) Patent Application Publication
(10) Pub. No.: US 2013/0024491 A1
(43) Pub. Date: Jan. 24, 2013

(54) PROCESSING NODE AND COMPUTER-READABLE RECORDING MEDIUM HAVING STORED THEREIN A PROGRAM

(71) Applicants: Hiroki Sogabe, Setagaya (JP); Minoru Takimoto, Chiba (JP)

(72) Inventors: Hiroki Sogabe, Setagaya (JP); Minoru Takimoto, Chiba (JP)

(73) Assignee: FUJITSU LIMITED, Kawasaki-shi (JP)

(21) Appl. No.: 13/535,515

(22) Filed: Jun. 28, 2012

(30) Foreign Application Priority Data
Jul. 20, 2011 (JP) 2011-159430

(51) Int. Cl. G06F 15/16

(52) U.S. Cl. 709/201

(57) ABSTRACT

A processing node includes, a processor configured to process the processing target data on the basis of the processing instruction and the processing period, wherein the processor (a) processes a processing target packet among the plurality of packets, (b) upon completion of processing of the processing target packet, determines using the timer whether the processing time exceeds the specified period, and (c) if it is determined in the determining that the processing period does not exceed the specified period, sets, as the processing target packet, a packet next to the processed processing target packet, repeats (a) to (c) until it is determined in the determining that the processing period exceeds the specified period, and completes processing on the processing target data if it is determined in the determining that the processing period exceeds the specified period.

### CROSS-REFERENCE TO RELATED APPLICATION

This application is based upon and claims the benefit of priority of the prior Japanese Patent Application No. 2011-159430, filed on Jul. 20, 2011, the entire contents of which are incorporated herein by reference.

### FIELD

The embodiment discussed herein is related to a processing node and a computer-readable recording medium having stored therein a program.

### BACKGROUND

In recent years, bulk data distributed processing has been increasingly applied in fields, such as services of analyzing a user's order history in Internet sales and recommending goods found in a buying history of goods having the same tendency as the user's order history, real-time prediction of, for example, stock prices and usage states of traffic systems, and sensor data time series analysis of production lines.

Solutions using bulk data distributed processing are beginning to be utilized. For example, analysis processing that has previously taken several days may now be carried out in several hours by processing a large volume of data in a distributed processing system in which a plurality of computers are arranged in parallel.

In a distributed processing system, a large volume of input data is divided in a management node, analysis processing is performed in a plurality of processing nodes, results of analysis processing are tabulated in the management node, and the result is output. Increasing the number of processing nodes reduces the processing time.

In a distributed processing system, when analysis target data that is to be processed by a processing node is binary data such as a packet capture file, the file structure inhibits the analysis target data from being divided into pieces of an arbitrary size and being analyzed.

When a plurality of pieces of analysis target data inhibited from being divided into pieces of an arbitrary size have different sizes, analysis processing of the plurality of pieces of analysis target data having different sizes is performed by a plurality of processing nodes. Each processing node performs analysis processing of analysis target data assigned thereto.

In cases where a plurality pieces of analysis target data have significantly different sizes, the processing time significantly varies among processing nodes to which the plurality pieces of analysis target data have been assigned. For example, a processing node to which analysis target data having a large size has been assigned takes longer time than other processing nodes in order to complete processing of analysis target data.

The problem of the embodiment is for processing nodes to substantially complete processing within a specified period when the processing nodes process data inhibited from being divided into pieces of an arbitrary size.

Japanese Laid-open Patent Publication Nos. 2006-338264, 2007-264794, and 2005-148911 are examples of related art.

### SUMMARY

According to an aspect of the embodiments, a processing node includes, a receiver configured to receive from a management node a processing instruction, the processing instruction including information including processing target data and a specified period including a period during which the processing target data is processed; a timer configured to measure processing period, which is duration time from receipt of the processing instruction; and a processor configured to process the processing target data on the basis of the processing instruction and the processing period and transmit an analysis result response to the management node; wherein the processing target data includes a plurality of packets combined together, and wherein the processor (a) processes a processing target packet among the plurality of packets, (b) upon completion of processing of the processing target packet, determines using the timer whether the processing period exceeds the specified period, and (c) sets, as the processing target packet, a packet next to the processed processing target packet, if it is determined in the determining that the processing period does not exceed the specified period, repeats (a) to (c) until it is determined in the determining that the processing period exceeds the specified period, and completes processing on the processing target data if it is determined in the determining that the processing period exceeds the specified period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a pictorial representation of a distributed processing system according to an embodiment;

FIG. 2 illustrates a block diagram of a management node and processing nodes according to the embodiment;

FIG. 3 illustrates a structure of a capture file;

FIG. 4 illustrates an exemplary processing node management table;

FIG. 5 illustrates an exemplary analysis target data management table;

FIG. 6 illustrates an exemplary specified period management table;

FIG. 7 illustrates a sequence chart of the distributed processing system according to the embodiment;

FIG. 8 illustrates a flowchart of processing of the processing node according to the embodiment;

FIG. 9 illustrates a flowchart of processing of the management node according to the embodiment;

FIG. 10 illustrates a detailed flowchart of providing an analysis instruction to a processing node (operation S625);

FIG. 11 illustrates a detailed flowchart of updating tables (operation S627); and

FIG. 12 illustrates a block diagram of an information processor (computer).

### DESCRIPTION OF EMBODIMENT

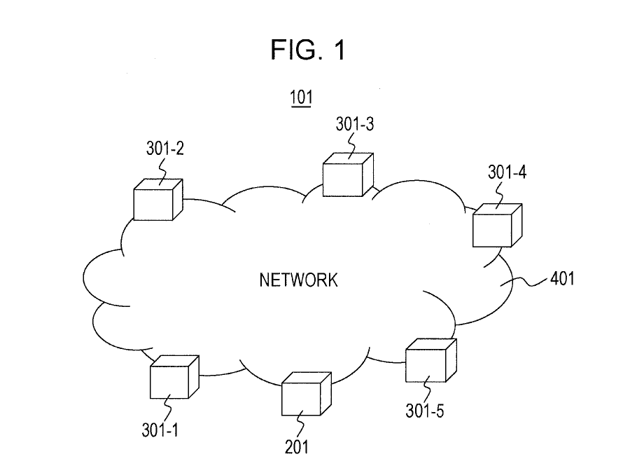

An embodiment will be described below with reference to the accompanying drawings. FIG. 1 illustrates a pictorial representation of a distributed processing system according to the embodiment. A distributed processing system 101 includes a management node 201 and a plurality of processing nodes 301-i (i=1 to 5).

The management node 201 and the processing nodes 301 are connected over a network 401. The management node 201 manages the processing capabilities of the processing nodes 301, and assigns processing to the processing nodes 301. In detail, the management node 201 notifies the processing nodes 301 of analysis target data and specified periods. Then, the management node 201 receives analysis results from the processing nodes 301.

On the basis of notifications from the management node 201, the processing nodes 301 analyze analysis target data, and transmit analysis results to the management node 201. The analysis target data is distributed among the processing nodes 301, and is transferred via the network 401 among the processing nodes 301 when the need arises.

Information regarding which analysis target data has been placed at which processing node 301 is managed by the management node 201.

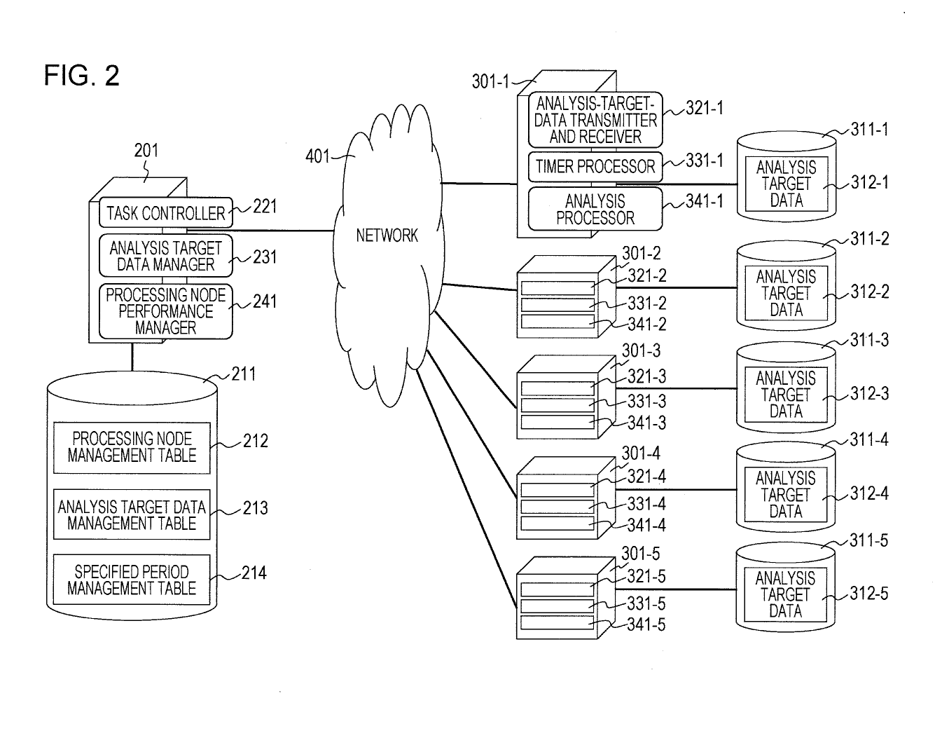

FIG. 2 illustrates a block diagram of the management node and the processing nodes according to the embodiment. The management node 201 includes a storage 211, a task controller 221, an analysis target data manager 231, and a processing node performance manager 241. The storage 211 is a storage unit that stores various data to be used by the management node 201.

The storage 211 is a magnetic disk unit or a semiconductor memory, for example. The storage 211 has a processing node management table 212, an analysis target data management table 213, and a specified period management table 214. The processing node management table 212, the analysis target data management table 213, and the specified period management table 214 will be described in detail below.

The task controller 221 notifies each processing node 301 of analysis target data and a specified period, and receives a processing result from each processing node 301. Regarding the analysis target data, the analysis target data manager 231 manages what data is stored in which of the processing nodes 301.

The processing node performance manager 241 manages information on the processing performance of each processing node 301. The processing node 301-i includes a storage 311-i, an analysis-target-data transmitter and receiver 321-i, a timer processor 331-i, and an analysis processor 341-i.

The storage 311-i is a storage unit that stores data processed by the processing node 301-i. The storage 311 is a magnetic disk unit or a semiconductor memory, for example. The storage 311-i has analysis target data 312-i.

The analysis target data 312-i is data to be analyzed by the processing node 301-i. The analysis target data 312 is a packet capture data file, for example. At the point of starting an analysis of the specified analysis target data 312-i on the basis of an instruction from the management node 201, the analysis-target-data transmitter and receiver 321-i requests another processing node to transmit the analysis target data 312-i if the specified analysis target data 312-1 has not been placed in the processing node to which the analysis-target-data transmitter and receiver 321-i belongs, and receives the analysis target data 312-i. The analysis-target-data transmitter and receiver 321-i also transmits the analysis target data 312-i in response to a request from another processing node.

The analysis-target-data transmitter and receiver 321-i transmits an analysis result obtained by the analysis processor 341-i to the management node 201. The timer processor 331-i counts time using a timer. On the basis of analysis target data 312 specified by the management node 201 and the specified period, the analysis processor 341-i analyzes that analysis target data 312.

The analysis target data of the embodiment will next be described. The analysis target data 312 of the embodiment is data that is not allowed to be analyzed from any position of the analysis target data in analysis processing. That is, the analysis target data 312 of the embodiment is data that is inhibited from being divided into pieces of a regular size or an arbitrary size in distributed processing.

In the embodiment, a packet capture data file (hereinbelow referred to as a “capture file”) is used as the analysis target data 312. A capture file is, for example, generated by collecting packet data flowing through a network and adding information, such as a header, to the packet data.

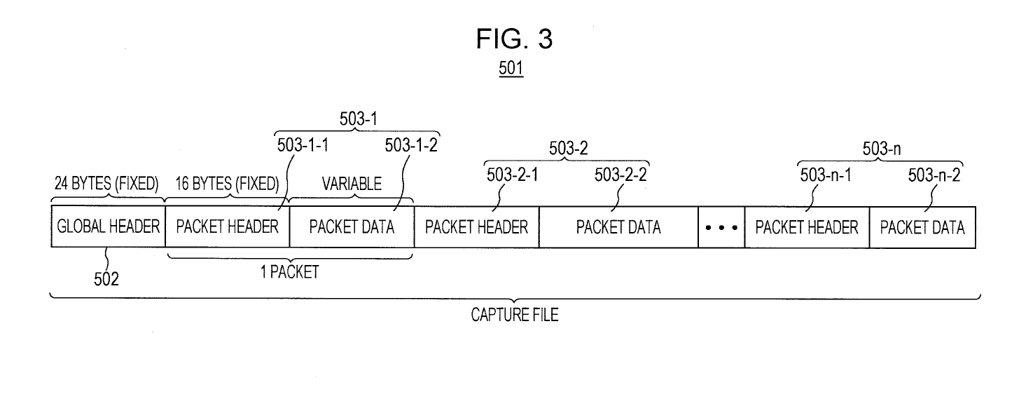

FIG. 3 illustrates a structure of a capture file. A capture file 501 is binary data in which a global header 502 and a plurality of packets 503-j (j=1 to n) are combined.

The packet 503-j is made up of the packet header 503-j-1 and the packet data 503-j-2. Information representing a capture file is described in the global header 502. The global header 502 is added by a capture device that has captured the packet data 503-j-2. The size of the global header 502 is fixed (24 bytes).

The time at which the packet data 503-j-2 was captured and the size of the packet header 503-j-2 are described in the packet header 503-j-1. The size of the packet header 503-j-1 is fixed (16 bytes).

The packet data 503-j-2 is data that flows through a network and that has been captured by a capture device. The packet data 503-j-2 has a variable size.

In the embodiment, one set composed of a packet header and packet data is referred to as “one packet data”, or “one packet”. In the embodiment, the capture file 501 is analyzed sequentially from the top packet 503-1.

One packet data in the capture file 501 does not have a fixed length, and the size of the packet data 503-j-2 is stored in the packet header 503-j-1. For this reason, unless processing is performed in order from the head byte, correct analysis of one packet data is not achieved.

If such a capture file is divided into pieces of a regular size or an arbitrary size when distributed processing is performed, there is a possibility that the capture file will be divided in the middle of one packet data. Thus, in order to enable processing to be performed in a plurality of processing nodes, a capture file is inhibited from being divided into pieces of a regular size or an arbitrary size.

In cases where capture files significantly differ in size, when the capture files are assigned to the processing nodes, there arises a significant difference in processing time among processing nodes. Unless the actual processing time is uniform among processing nodes, the entirety of the processing is not performed at a high speed.

That is, when the distributed processing is performed on a capture file that is inhibited from being divided into pieces of an arbitrary size, there is a problem in that the actual processing time is not uniform among processing nodes, and, as a result, the total processing time is long.

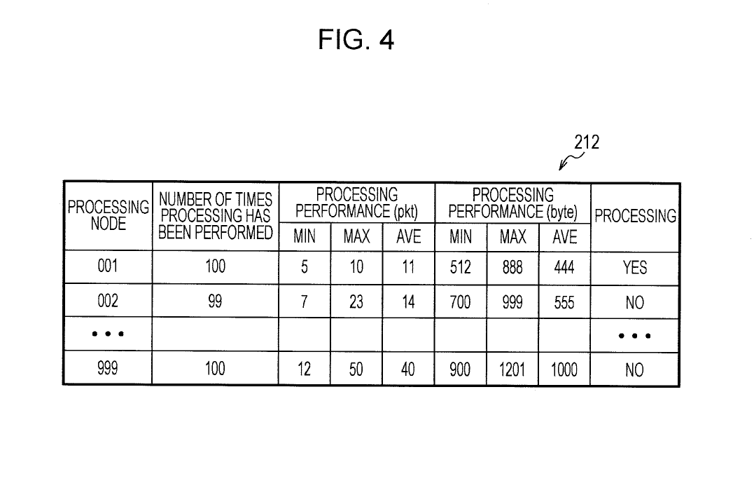

FIG. 4 illustrates an exemplary processing node management table. The processing node management table 212 includes items, “processing node”, “number of times processing has been performed”, “processing performance (pkt)”, “processing performance (byte)”, and “processing”. In the processing node management table 212, the items are described in such a manner that the “number of times processing has been performed”, “processing performance (pkt)”, “processing performance (byte)”, and “processing” are associated with the “processing node”.

The item “processing node” represents an identifier of the processing nodes 301. For example, identifiers such as 001 and 002 are assigned to the processing nodes 301-1 to 301-5. The item “number of times processing has been performed” represents the number of times analysis processing has been performed.

The item “processing performance (pkt)” represents the minimum value (min), the maximum value (max), and the average value (aye) of the number of packets per unit time (e.g., 1 second) that the respective processing node 301 has processed in analysis processing. The item “processing performance (byte)” represents the minimum value (min), the maximum value (max), and the average value (aye) of the number of packets per unit time (e.g., 1 second) that the respective processing node 301 has processed in analysis processing.

The item “processing” represents whether the processing node 301 is currently performing analysis processing. In this column, “YES” represents the fact that the respective processing node 301 is currently performing processing, and “NO” represents the fact that the respective processing node 301 is not currently performing processing.

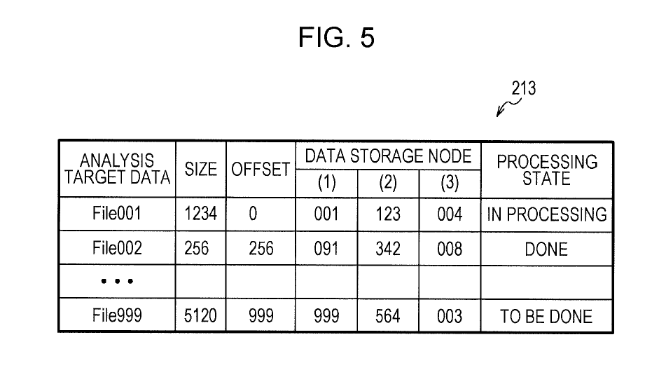

FIG. 5 illustrates an exemplary analysis target data management table. In the analysis target data management table 213, the processing states of the analysis target data 312, the processing nodes 301 in which the analysis target data 312 is stored, and other information are described. The analysis target data management table 213 includes items, “analysis target data”, “size”, “offset”, “data storage node”, and “processing state”. In the analysis target data management table 213, the items are described in such a manner that “size”, “offset”, “data storage node”, and “processing state” are associated with “analysis target data”.

The item “analysis target data” represents the file name of analysis target data, that is, the file name of a capture file. The item “size” represents the size of analysis target data.

The item “offset” represents the position of the end of processed data in the analysis target data, or represents the position of the head of data to be processed in the analysis target data. That is, the item “offset” represents a position at which processing is to start when the processing node 301 processes the analysis target data 312.

The item “data storage node” represents a processing node in which analysis target data is stored. In FIG. 5, a plurality of identifiers of the processing nodes in which analysis target data is stored are mentioned. The item “processing state” represents the state of analysis processing of analysis target data. In this column, “processing” represents the fact that analysis target data is being processed, “done” represents the fact that analysis target data has been processed, and “to be done” represents the fact that analysis target data has not yet been processed.

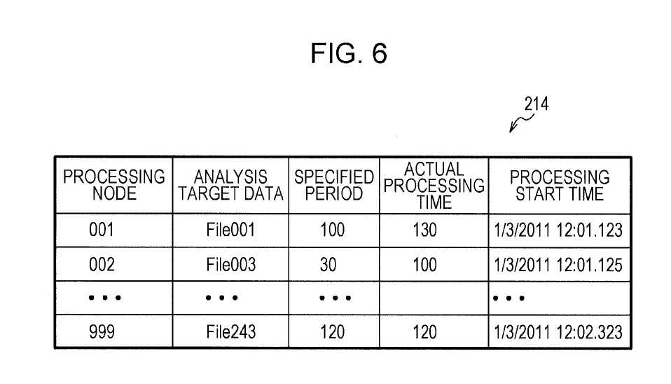

FIG. 6 illustrates an exemplary specified period management table. The specified period management table 214 includes items, “processing node”, “analysis target data”, “specified period”, “actual processing time”, and “processing start time”. In the specified period management table 214, the items are described in such a manner that “analysis target data”, “specified period”, “actual processing time”, and “processing start time” are associated with “processing node”.

The item “processing node” represents the identifier of a processing node. The item “analysis target data” represents the file name of the analysis target data to be processed by a processing node. The item “specified period” represents a period during which the respective processing node 301 performs analysis processing. The “specified period” is expressed in seconds.

The item “actual processing time” represents time from transmission of an analysis instruction to receipt of an analysis result response. The “actual processing time” is expressed in seconds. The item “processing start time” represents a time at which an analysis instruction is transmitted to the respective processing node 301.

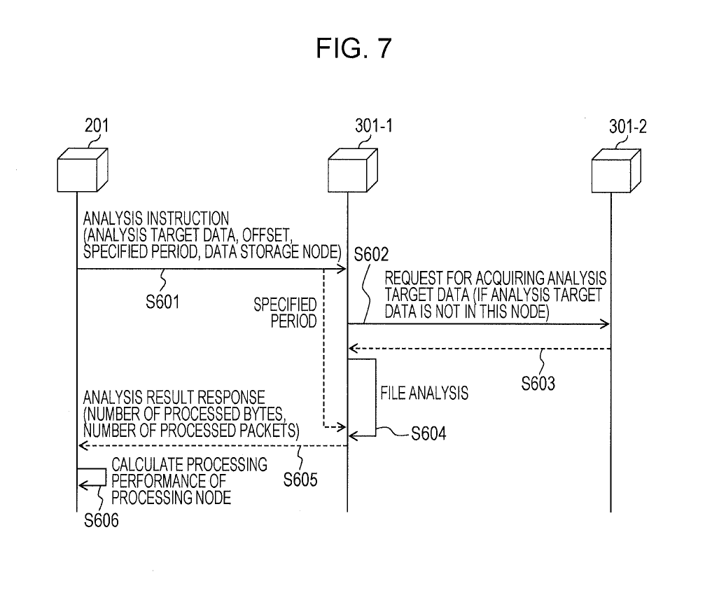

FIG. 7 illustrates a sequence chart of the distributed processing system according to the embodiment. The management node 201 provides a notification including analysis target data and a specified period. The notification differs for each processing node 301.

Here, the case where the management node 201 transmits an analysis instruction to the processing node 301-1 is described as an example. The management node 201 transmits an analysis instruction to the processing node 301-1 (operation S601). The analysis instruction includes information representing analysis target data to be processed by the processing node 301-1, an offset, and a specified period. Further included in the analysis instruction is information representing a processing node (data storage node) in which the analysis target data to be processed by the processing node 301-1 is stored.

Upon receiving the analysis instruction, the processing node 301-1 determines whether the analysis target data specified in the analysis instruction has been placed in that processing node 301-1, and acquires the analysis target data specified in the analysis instruction. Whether analysis target data is stored in the processing node itself where processing is to be performed is determined with reference to the information representing a data storage node included in the analysis instruction.

In detail, if analysis target data is not stored in the processing node 301-1, the processing node 301-1 transmits a request for acquiring analysis target data to a processing node (here, the processing node 301-2 is assumed) in which analysis target data is stored (operation S602). Upon receiving the request for acquiring analysis target data, the processing node 301-2 transmits the specified analysis target data to the processing node 301-1. Alternatively, if the specified analysis target data is stored in the processing node 301-1, the processing node 301-1 reads the analysis target data from the storage 311-1.

Upon reading the analysis target data from the processing node 301-1 or receiving the analysis target data from the processing node 301-2, the processing node 301-1 analyzes the analysis target data from the position of the offset (operation S604). The processing node 301-1 performs analyzing until the following two conditions are met: processing of a packet being processed is completed, and time from receipt of the analysis instruction exceeds the specified time.

The processing node 301-1 transmits an analysis result response including an analysis result, the number of processed packets, the number of processed bytes, and other information to the management node 201 (operation S605). The management node 201 receives the analysis result response, and calculates the processing performance of the processing node 301-1 based on the received number of processed packets and number of processed bytes.

As described above, the management node 201 not only assigns analysis target data to processing nodes and causes the processing nodes to analyze the analysis target data, but also calculates the processing performance (the number of processed packets and the number of processed bytes) of each processing node 301. Using the calculated processing performance, the management node 201 determines a specified period to be provided to each processing node 301, the details of which will be described below.

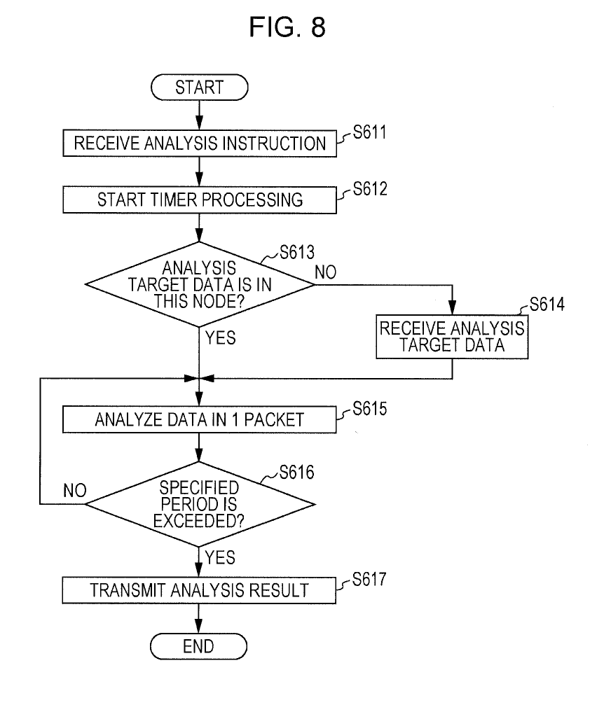

The details of processing (operations S602 to S605) of the processing node will next be described. FIG. 8 illustrates a flowchart of processing of the processing node according to the embodiment. Here, a description is given of the case where the processing node 301-1 performs processing. The analysis target data is assumed to be a capture file.

In operation S611, the analysis processor 341-1 receives an analysis instruction from the management node 201. Note that the analysis instruction includes information representing analysis target data to be processed by the processing node 301-1, an offset, a specified period, and information representing a processing node (a data storage node) in which the analysis target data to be processed by the processing node 301-1 is stored.

In operation S612, the timer processor 331-1 starts timer processing upon receiving the analysis instruction from the management node 201. That is, the timer processor 331-1 counts time from receipt of the analysis instruction.

In operation S613, the analysis-target-data transmitter and receiver 321-1 determines whether the analysis target data specified in the analysis instruction has been placed in the processing node to which the analysis-target-data transmitter and receiver 321-1 belongs (that is, the processing node 301-1). Whether the specified analysis target data is stored in the processing node itself where processing is to be performed is determined with reference to information representing a data storage node included in the analysis instruction.

If the analysis target data has been placed in the processing node in question, then the analysis processor 341-1 reads the analysis target data from the storage 311-1, and control proceeds to operation S615. If the analysis target data has not been placed in the processing node in question, then the analysis-target-data transmitter and receiver 321-1 transmits a request for transmission of the analysis target data to a data storage node, and control proceeds to operation S614. Upon receiving the request for transmission, the data storage node transmits the analysis target data to the transmission source (the processing node 301-1) of the request for transmission.

In operation S614, the analysis-target-data transmitter and receiver 321-1 receives the analysis target data from the data storage node. Hereinafter, the analysis processor 341-1 performs analysis processing of the analysis target data read from the storage 311-1 or analysis processing of the analysis target data received from the data storage node.

In operation S615, the analysis processor 341-1 analyzes a packet to be processed. The packet to be processed is a packet at the position of the offset, which is included in the analysis instruction, in the capture file 501 when processing in operation S615 is performed for the first time, and the packet to be processed is a packet specified in operation S616, which will be described below, when processing in operation S615 is performed for the second and subsequent times.

As described above, in operation S615, data in one packet is analyzed. In operation S616, referring to the timer, the analysis processor 341-1 determines whether time from receipt of the analysis instruction exceeds the specified time. If the time from receipt of the analysis instruction exceeds the specified time, then control proceeds to operation S617. If the time from receipt of the analysis instruction does not exceed the specified time, then control returns to operation S615, where the analysis processor 341-1 sets, as a packet to be processed, a packet next to the packet analyzed in operation S615 in the capture file 501. For example, in the case where the packet 503-1 has been analyzed, the next packet to be processed is the packet 503-2.

In operation S617, the analysis-target-data transmitter and receiver 321-1 transmits an analysis result response to the management node 201. The analysis result response includes an analysis result, the number of processed packets, and the number of processed bytes. The analysis result is a result of analysis processing of packets that has been performed by the analysis processor 341-1.

The number of processed packets is the number of packets analyzed by the analysis processor 341-1 until time from receipt of the analysis instruction exceeds the specified period. The number of processed bytes is the sum total of the sizes of packets analyzed by the analysis processor 341-1 until the time from receipt of the analysis instruction exceeds the specified period.

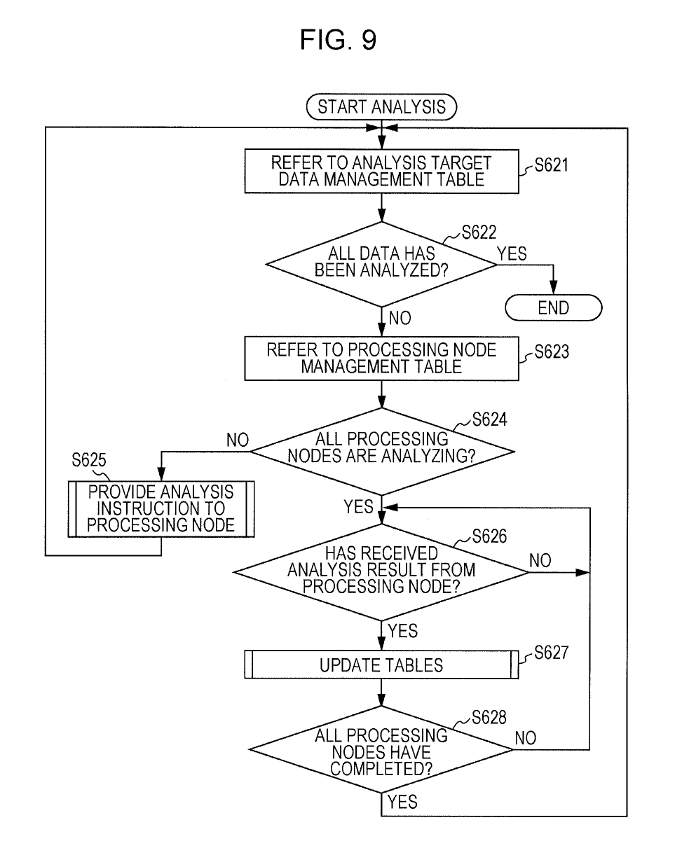

Processing of the management node 201 will next be described. FIG. 9 illustrates a flowchart of processing of the management node according to the embodiment. The management node 201 receives an instruction for starting an analysis from a user, and then performs the following processing.

In operation S621, the task controller 221 refers to the analysis target data management table 213. In operation S622, on the basis of the analysis target data management table 213, the task controller 221 determines whether all the analysis target data has been analyzed. If all the analysis target data has been analyzed, then the process ends, and if one or more pieces of the analysis target data have not yet been analyzed, then control proceeds to operation S623.

In a determination of whether all the analysis target data has been analyzed or not, if all the processing states of the analysis target data management table 213 are “done”, the task controller 221 determines that all the analysis target data has been analyzed, and if one or more processing states are “processing” or “to be done”, the task controller 221 determines that one or more pieces of analysis target data have not been analyzed.

In operation S623, the task controller 221 refers to the processing node management table 212. In operation S624, on the basis of the processing node management table 212, the task controller 221 determines whether all the processing nodes 301 are analyzing analysis target data. If all the processing nodes 301 are analyzing analysis target data, then control proceeds to operation S626, and if one or more processing nodes 301 are not analyzing analysis target data, then control proceeds to operation S625.

In a determination of whether all the processing nodes 301 are analyzing analysis target data, if, regarding the item “processing” of the processing node management table 212, “YES” is indicated for all the processing nodes, then the task controller 221 determines that all the processing nodes 301 are analyzing analysis target data, and if “NO” is indicated for one or more processing nodes 301, then the task controller 221 determines that one or more processing nodes 301 are not analyzing analysis target data.

In operation S625, the task controller 221 performs a process for providing an analysis instruction to a processing node. Note that the details of this process will be described below. In operation S626, the task controller 221 waits until receiving an analysis result from the processing node 301, and control proceeds to operation S627 when the task controller 221 receives the analysis result from the processing node 301.

In operation S627, the management node 201 updates tables (the processing node management table 212, the analysis target data management table 213, and the specified period management table 214). The details of a process for updating tables (operation S627) will be described below.

In operation S628, the task controller 221 determines whether analysis processing of all the processing nodes 301 is completed. If analysis processing of all the processing nodes 301 is completed, then control proceeds to operation S621, and if analysis processing of one or more processing nodes 301 is not completed, the control returns to operation S626.

Whether analysis processing of all the processing nodes 301 is completed or not is determined by the task controller 221 with reference to the processing node management table 212. In detail, if, regarding the item “processing” of the processing node management table 212, “NO” is indicated for all the processing nodes, then the task controller 221 determines that the analysis processing of all the processing nodes 301 is completed, and if “YES” is indicated for one or more processing nodes 301, then the task controller 221 determines that the analysis processing of one or more processing nodes 301 is not completed.

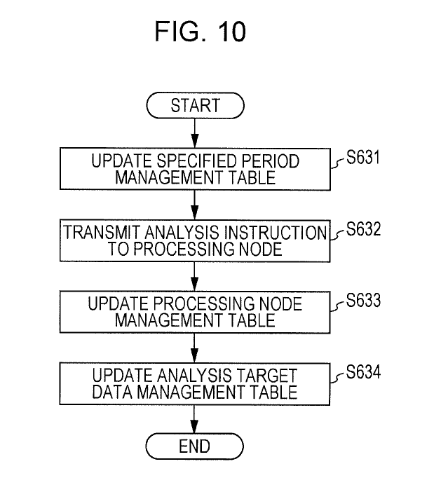

FIG. 10 illustrates a detailed flowchart of providing an analysis instruction to a processing node (operation S625). Note that an analysis instruction or instructions are provided to the respective processing node or nodes that have not yet performed analysis processing.

In operation S631, the task controller 221 updates the specified period management table 214. In detail, referring to the specified period management table 214, the task controller 221 calculates the average value of actual processing time of all processing nodes. A difference between the calculated average value and the actual processing time of each processing node is calculated, and the difference is added to the specified period of each processing node. The specified periods after the addition are regarded as new specified periods, and the specified periods in the specified period management table 214 are updated.

In operation S632, the task controller 221 transmits an analysis instruction to the processing node 301. In detail, referring to the analysis target data management table 213, the task controller 221 detects analysis target data whose processing state is “processing” or “to be done”, and assigns the detected analysis target data, as data to be processed, appropriately to processing nodes. However, the same analysis target data is not to be assigned simultaneously to a plurality of processing nodes.

Referring to the specified period management table 214, the task controller 221 causes the assigned analysis target data, the offset of that assigned analysis target data, and a specified period to be included in an analysis instruction, and transmits the analysis instruction to the processing node 301.

The task controller 221 updates the analysis target data of the specified period management table 214 with the assigned analysis target data, and updates the processing start time of the specified period management table 214 with time at which the analysis instruction has been transmitted.

In operation S633, the processing node performance manager 241 updates the “processing” of the processing node management table 212 such that “YES” is indicated. In operation S634, the analysis target data manager 231 updates the “processing state” of the analysis target data management table 213 corresponding to the analysis target data assigned to the processing node 301 so that “processing” is indicated.

As a result of processing of operation S631, the specified period of a processing node whose actual processing time is longer than the average value is decreased, and the specified period of a processing node whose actual processing time is shorter than the average value is increased. Determining the specified periods in such a manner reduces variations in actual processing time among processing nodes. The actual processing time is substantially uniform among processing nodes. Therefore a situation where completion of processing of a processing node with low processing performance is waited for may be avoided.

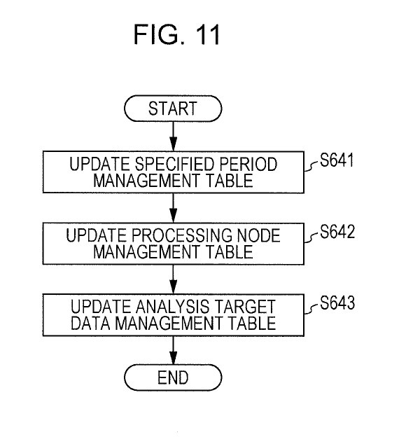

FIG. 11 illustrates a detailed flowchart of updating tables (operation S627). In operation S641, referring to the specified period management table 214, the task controller 221 calculates a difference between time at which an analysis result is received and the processing start time, as actual processing time, and updates the specified period management table 214.

In operation S642, using the actual processing time and the analysis result, the processing node performance manager 241 updates records corresponding to the processing node 301 that has transmitted the analysis result in the processing node management table 212.

In detail, the processing node performance manager 241 adds one to the number indicated in the “number of times processing has been performed” of the processing node management table 212. Using the number of processed packets and the number of processed bytes included in the analysis result, the processing node performance manager 241 determines the averages of the processing performance (pkt) and the processing performance (byte) of the processing node in question, including those of this analysis processing, and the processing node performance manager 241 updates the average value (aye) of the processing performance (pkt) and the average value (aye) of the processing performance (byte) of the processing node management table 212. When the number of processed packets included in the analysis result is smaller than the minimum value (min) or larger than the maximum value (max) of the processing performance (pkt) of the processing node management table 212, the processing node performance manager 241 updates the minimum value (min) or the maximum value (max) with that number of processed packets. When the number of processed bytes included in the analysis result is smaller than the minimum value (min) or larger than the maximum value (max) of the processing performance (byte) of the processing node management table 212, the processing node performance manager 241 updates the minimum value (min) or the maximum value (max) with that number of processed bytes.

Further, the analysis target data manager 231 sets “NO” in “processing” of the processing node management table 212. In operation S643, using the analysis result, the analysis target data manager 231 updates records corresponding to the analyzed analysis target data in the analysis target data management table 213.

In detail, the analysis target data manager 231 adds the number of processed bytes included in the analysis result to the offset, calculates a new offset, and updates the analysis target data management table 213 with the new offset.

The analysis target data manager 231 also updates the processing state of the analysis target data management table 213. With the distributed processing system of the embodiment, when a processing node processes data inhibited from being divided into pieces of a regular size or an arbitrary size, processing may be substantially completed in a specified period regardless of the size of data assigned to the processing node. That is, the processing node does not complete processing at the time when the processing node has processed all the assigned data. Instead, the processing node completes processing on the basis of a specified period.

With the distributed processing system of the embodiment, completion of processing is determined every time a processing node processes one packet data, and therefore the processing is not completed at a halfway position. This allows the next processing to be started from the head of the next packet. Data inhibited from being divided into pieces of a regular size or an arbitrary size may therefore be processed.

With the distributed processing system of the embodiment, analysis processing is completed on the basis of a specified period. A situation where processing is not completed until a processing node with low processing capability has completely processed the data having a large size assigned thereto may therefore be avoided. That is, since processing is completed on the basis of a specified period, a problem in that the whole processing time is increased under the influence of processing of a specific processing node, such as a processing node with low processing capability, may be avoided.

With the distributed processing system of the embodiment, the specified period of each processing node may be determined such that actual processing time is uniform among processing nodes. Thus, the actual processing time of processing nodes is uniform, which makes the whole processing speed stable, enabling processing to be performed efficiently.

With the distributed processing system of the embodiment, since the specified period is calculated on the basis of actual processing time for every one processing according to the specified period, the specified period may be determined in consideration of the load of a processing node or network traffic conditions. That is, the specified period may be determined on the basis of processing capability that changes dramatically, not on the basis of the static processing capability that is known beforehand. It is to be noted that while the processing node 301 performs analysis processing in the embodiment, this is not limitative. The processing node 301 may perform arbitrary processing, such as encryption, decoding, compression, extension, and data conversion.

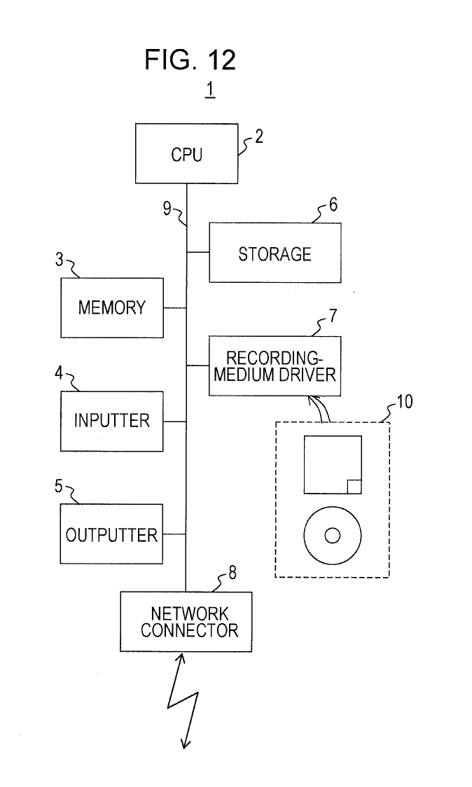

FIG. 12 illustrates a block diagram of an information processor (computer). The management node 201 and the processing nodes 301 of the embodiment are implemented by an information processor 1 as illustrated in FIG. 12, for example. The information processor 1 includes a central processing unit (CPU) 2, a memory 3, an inputter 4, an outputter 5, a storage 6, a recording medium driver 7, and a network connector 8, and they are connected with one another by a bus 9.

The CPU 2 is a central processing unit that controls the entirety of the information processor 1. The CPU 2 corresponds to the task controller 221, the analysis target data manager 231, the processing node performance manager 241, the analysis-target-data transmitter and receiver 321, the timer processor 331, and the analysis processor 341.

The memory 3 is a memory, such as a read only memory (ROM) or a random access memory (RAM), which temporarily stores a program or data stored in the storage 6 (or a portable recording medium 10) when the program is executed. The CPU 2 performs the above-described various processing by running programs using the memory 3.

In this case, program codes themselves read from the portable recording medium 10, for example, implement the functions of the embodiment. The inputter 4 is a keyboard, a mouse, or a touch panel, for example.

The outputter 5 is a display or a printer, for example. The storage 6 is a magnetic disk unit, an optical disk unit, or a tape device, for example. The information processor 1 keeps the above-mentioned programs and data stored in the storage 6, and reads them into the memory 3 and uses them when the need arises.

The memory 3 or the storage 6 corresponds to the storages 211 and 311. The recording medium driver 7 performs driving for the portable recording medium 10 and accesses contents recorded thereon. As the portable recording medium, an arbitrary computer-readable recording medium such as a memory card, a flexible disk, a compact disk read only memory (CD-ROM), an optical disk, or a magneto-optical disk is used. A user stores the above-mentioned programs and data in this portable recording medium 10, and reads them into the memory 3 and uses them when the need arises.

The network connector 8 is connected to an arbitrary communication network, such as a local-area network (LAN), and performs data conversion for communications.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A processing node, comprising:
a receiver configured to receive from a management node a processing instruction, the processing instruction including information including processing target data and a specified period including a period during which the processing target data is processed;
a timer configured to measure processing period, which is duration time from receipt of the processing instruction; and
a processor configured to process the processing target data on the basis of the processing instruction and the processing period and transmit an analysis result response to the management node,
wherein the processing target data includes a plurality of packets combined together, and
wherein the processor
(a) processes a processing target packet among the plurality of packets,
(b) upon completion of processing of the processing target packet, determines using the timer whether the processing period exceeds the specified period, and
(c) sets, as the processing target packet, a packet next to the processed processing target packet, if it is determined in the determining that the processing period does not exceed the specified period,
repeats (a) to (c) until it is determined in the determining that the processing period exceeds the specified period, and
completes processing on the processing target data if it is determined in the determining that the processing period exceeds the specified period.

2. The processing node according to claim 1, wherein
the processing instruction further includes an offset representing a start position of processing of the processing target data, and
the processor performs processing of the processing target data from a position of the offset of the processing target data.

3. The processing node according to claim 1, wherein
the processor causes the number of bytes of at least one packet, the at least one packet being processed until it is determined in the determining that the processing time exceeds the specified period, to be included, as the number of processed bytes, in the analysis result response.

4. The processing node according to claim 2, wherein
the processor causes the number of bytes of at least one packet, the at least one packet being processed until it is determined in the determining that the processing time exceeds the specified period, to be included, as the number of processed bytes, in the analysis result response.

5. A computer readable recording medium having stored therein a program for causing a computer to execute a digital signature process comprising:
receiving from a management node a processing instruction, the processing instruction including information including processing target data and a specified period including a period during which the processing target data is processed;
measuring processing period, which is duration time from receipt of the processing instruction;
processing the processing target data on the basis of the processing instruction and the processing period and
transmitting an analysis result response to the management node,
wherein the processing target data includes a plurality of packets combined together, and
wherein the process of processing the processing target data includes
(a) processing a processing target packet among the plurality of packets,
(b) upon completion of processing of the processing target packet, determining using the timer whether the processing time exceeds the specified period, and
(c) seting, as the processing target packet, a packet next to the processed processing target packet, if it is determined in the determining that the processing period does not exceed the specified period,
repeats (a) to (c) until it is determined in the determining that the processing time exceeds the specified period, and
completes processing on the processing target data if it is determined in the determining that the processing period exceeds the specified period.

6. The computer readable recording medium having stored therein a program according to claim 5, wherein
the processing instruction further includes an offset representing a start position of processing of the processing target data, and
the process of processing the processing target data includes processing the processing target data from a position of the offset of the processing target data.

7. The computer readable recording medium having stored therein a program according to claim 5, wherein
the process of processing the processing target data causes the number of bytes of at least one packet, the at least one packet being processed until it is determined in the determining that the processing time exceeds the specified period, to be included, as the number of processed bytes, in the analysis result response.

8. The computer readable recording medium having stored therein a program according to claim 6, wherein
the process of processing the processing target data causes the number of bytes of at least one packet, the at least one packet being processed until it is determined in the determining that the processing time exceeds the specified period, to be included, as the number of processed bytes, in the analysis result response.
